(19) United States
(12) Patent Application Publication
(10) Pub. No.: US 2008/0320178 A1
(43) Pub. Date: Dec. 25, 2008

(54) DMA transfer apparatus

(76) Inventors: Motoyasu Shirasaki, Kanagawa (JP); Akihito Tsukamoto, Tokyo (JP)

Correspondence Address: MCDERMOTT WILL & EMERY LLP, 600 13TH STREET, NW, WASHINGTON, DC, 20005-3096, US

(21) Appl. No.: 11/812,701

(22) Filed: Jun. 21, 2007

(51) Int. Cl. G06F 13/28

(52) U.S. Cl. 710/22

(57) ABSTRACT

A DMA transfer apparatus 101 is equipped with a DMA control block 102 and a FIFO-incorporated block 103. The DMA control block 102 is connected, as a bus master, to a DMA bus capable of burst transfer and having a function of controlling a burst transfer by generating burst access for sending data consecutively a certain number of times while incrementing the address after sending a command. The FIFO-incorporated block 103 is connected the DMA bus as its slave and having a FIFO whose address is mapped to a continuous address space. An arrangement is provided so that a parameter dedicated to FIFO transfer can be set in an addressing mode setting register of a control register group of the DMA control block 102, whereby a burst transfer to or from the FIFO whose address is mapped to the continuous address space is controlled.

### BACKGROUND OF THE INVENTION

1. Field of the Invention

The present invention relates to a DMA transfer apparatus and, more particularly, to a technique for enabling a burst transfer in a DMA transfer apparatus that is equipped with an input/output interface for connection of low-speed peripheral hardware and a FIFO as a buffer memory.

2. Description of the Related Art

In conventional computer systems including a CPU and high-speed peripheral hardware, data are transferred directly between a memory and the high-speed peripheral hardware by using a DMA transfer apparatus, whereby the processing load of the CPU is reduced.

There are computer systems which perform a DMA transfer and have a burst transfer function of sending an address once in synchronism with a clock signal and then transferring data consecutively a certain number of times while incrementing the address. A high-speed data transfer between the memory and the high-speed peripheral hardware is thus enabled.

On the other hand, peripheral hardware is known which is equipped with, to receive and output data from and to relatively low-speed peripheral hardware, an input/output interface as a local bus for connection of the low-speed peripheral hardware and a FIFO (first-in first-out) as a buffer memory for speed difference buffering between a DMA transfer and the low-speed peripheral hardware (refer to Patent document 1, for example).

Patent document 1: JP-A-2004-94970

In the prior art, a burst transfer cannot be used in performing a DMA transfer to or from peripheral hardware having a FIFO, for the following reason. Since each of a data transmission register and a data reception register of the FIFO is mapped to a single address, to transfer data consecutively it is necessary to access the same address repeatedly.

Therefore, it is necessary to repeat a single transfer to or from the peripheral hardware having the FIFO, as a result of which the bus bandwidth is occupied for an unduly long time for the low-speed peripheral hardware. A problem arises that this affects a data transfer to or from another piece of, high-speed peripheral hardware that also needs the bus bandwidth and thereby lowers the performance of the entire system.

### SUMMARY OF THE INVENTION

An object of the present invention is to enable a burst transfer to or from a FIFO in a DMA transfer apparatus that is equipped with the FIFO as a buffer memory and an input/output interface for connection of low-speed peripheral hardware.

A DMA transfer apparatus according to the invention comprises a DMA control block connected, as a bus master, to a DMA bus capable of burst transfer and having a function of controlling a burst transfer by generating burst access for sending data consecutively a certain number of times while incrementing the address after sending a command; and a FIFO-incorporated block connected the DMA bus as a slave thereof and having a FIFO whose address is mapped to a continuous address space.

In the above configuration, since the continuous address space is mapped to the FIFO of the FIFO-incorporated block, burst access is possible in which a command is sent to the FIFO first and then data are sent consecutively a certain number of times while the address is incremented. A high-speed DMA transfer to the FIFO is thus realized.

The DMA transfer apparatus according to the invention may be such that, in the above configuration, the FIFO-incorporated block comprises an address decoder for detecting, at a start of burst access, that an address at an end of a burst transfer will exceed the address space of the FIFO, and outputting an error notice.

In this configuration, since an expected error is detected at the start of burst access, a measure can be taken before the start of a DMA transfer against an event that the address will exceed the address space of the FIFO as a result of a burst transfer.

The DMA transfer apparatus according to the invention may be such that, in the above configuration, the DMA control block comprises a control register section in which a CPU sets transfer parameters; a bus interface section capable of generating burst access via the DMA bus according to the parameters set in the control register section; and an addressing mode in which addition to a transfer destination address or a transfer source address is performed during a burst transfer and subtraction into an address at a start of the burst transfer is performed automatically at an end of the burst transfer.

Since the address space assigned to the FIFO is restricted, the address exceeds the address space as it is incremented repeatedly. However, this configuration enables burst access in which access is made repeatedly an arbitrary number of times because this configuration is provided with a function of resetting a generated address in each burst transfer.

The DMA transfer apparatus according to the invention may be such that, in the above configuration, the FIFO-incorporated block comprises a transmission FIFO for receiving and outputting data of plural stages; an output interface section for taking data out of the transmission FIFO and outputting the data to the outside in a prescribed format; and a burst length selection circuit for informing the DMA control block of a maximum burst length that does not cause a FIFO overflow on the basis of the number of stages of data stacked in the transmission FIFO and a usable burst length setting value table.

This configuration makes it possible to avoid a FIFO overflow and to minimize the bus occupation time because a mechanism of automatically selecting access of an optimum burst length on the basis of the number of stages of data stacked in the FIFO is provided.

The DMA transfer apparatus according to the invention may be such that, in the above configuration, the FIFO-incorporated block comprises a reception FIFO for receiving and outputting data of plural stages; an input interface section for receiving data externally in a prescribed format and loading the data into the reception FIFO; and a burst length selection circuit for informing the DMA control block of a maximum burst length that does not cause a FIFO underflow on the basis of the number of stages of data stacked in the reception FIFO and a usable burst length setting value table.

This configuration makes it possible to avoid a FIFO underflow and to minimize the bus occupation time because a mechanism of automatically selecting access of an optimum burst length on the basis of the number of stages of data stacked in the FIFO is provided.

The DMA transfer apparatus according to the invention may be such that, in the above configuration, the DMA control block comprises a burst length selection circuit capable of generating burst access of a burst length that is a plural number, for selecting, in each data transfer, access of a maximum burst length that does not cause a FIFO overflow or underflow on the basis of the number of stages of data stored in the FIFO and a usable burst length setting value table.

This configuration makes it possible to always perform a DMA transfer with a usable longest burst length without causing a FIFO overflow or underflow and hence to minimize the bus occupation time.

According to the invention, a burst transfer is enabled in a DMA transfer to or from a FIFO, whereby a high-speed DMA transfer is realized which uses a burst transfer to or from low-speed peripheral hardware having a FIFO. As a result, the ratio of occupation of a bus bandwidth by the low-speed peripheral hardware can be reduced and the performance of the entire system can be increased.

### BRIEF DESCRIPTION OF THE DRAWINGS

FIG. 1 is a block diagram showing the configuration of a DMA transfer apparatus according to an embodiment of the present invention.

FIG. 2 is an exemplary address map of a FIFO-incorporated block of the DMA transfer apparatus according to the invention.

FIG. 3 is a timing chart of a DMA transfer to or from a FIFO in the DMA transfer apparatus according to the invention.

FIG. 4 is an exemplary address map of a conventional FIFO-incorporated device.

FIG. 5 is a timing chart of a DMA transfer to or from the conventional FIFO-incorporated device.

FIG. 6 is a timing chart showing a data transmission procedure of a burst transfer to a FIFO using the DMA transfer apparatus according to the invention.

FIG. 7 is a timing chart showing a data reception procedure of a burst transfer from a FIFO using the DMA transfer apparatus according to the invention.

FIG. 8 is a timing chart showing a burst length control for avoiding a FIFO overflow in a burst transfer using the DMA transfer apparatus according to the invention.

FIG. 9 is a timing chart showing a burst length control for avoiding a FIFO underflow in a burst transfer using the DMA transfer apparatus according to the invention.

### DESCRIPTION OF THE PREFERRED EMBODIMENTS

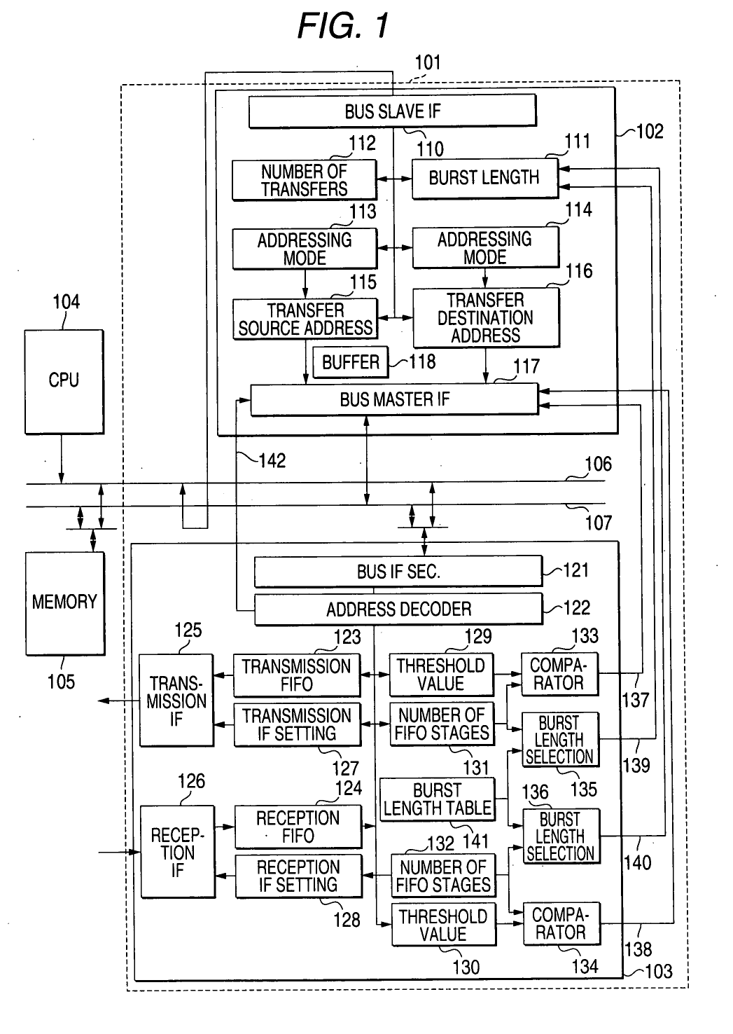

FIG. 1 is a block chart showing the configuration of a DMA transfer apparatus according to an embodiment of the present invention. In FIG. 1, reference numeral 101 denotes a DMA transfer apparatus according to the invention; 104, a CPU; 105, a memory; 106, a CPU bus having the CPU 104 as a bus master; and 107, a DMA bus capable of not only a single transfer but also two-time, four-time, eight-time, and 16-time burst transfers. Other various kinds of hardware that are connected for various uses of the system are not shown in FIG. 1.

In the DMA transfer apparatus 101, reference numeral 102 denotes a DMA control block which has CPU-104-settable control registers 111-116 and a bus master interface 117 and serves as a bus master of the DMA bus 107. Reference numeral 103 denotes a FIFO-incorporated block which is equipped with communication interface for data communication with external devices and FIFOs as buffer memories.

A bus arbitration circuit allows access to the FIFO-incorporated block 103 from each of the CPU bus 106 and the DMA bus 107. To exchange data with an external device, the CPU 104 sets the control registers 111-116 of the DMA control block 102 and then a DMA transfer is started in response to a DMA request signal 137 or 138 that is output from the FIFO-incorporated block 103. Data that are to be transmitted to or have been received from an external device are transferred from or to the memory 105 with buffering by a transmission FIFO 123 or a reception FIFO 124 having a 16-word depth.

When a bus interface section 121 of the FIFO-incorporated block 103 receives an access request command from the CPU 104 or the DMA control block 102, an address decoder 122 decodes addresses specified by the bus master and generates accesses to control registers 127-130, the transmission FIFO 123, and the reception FIFO 124.

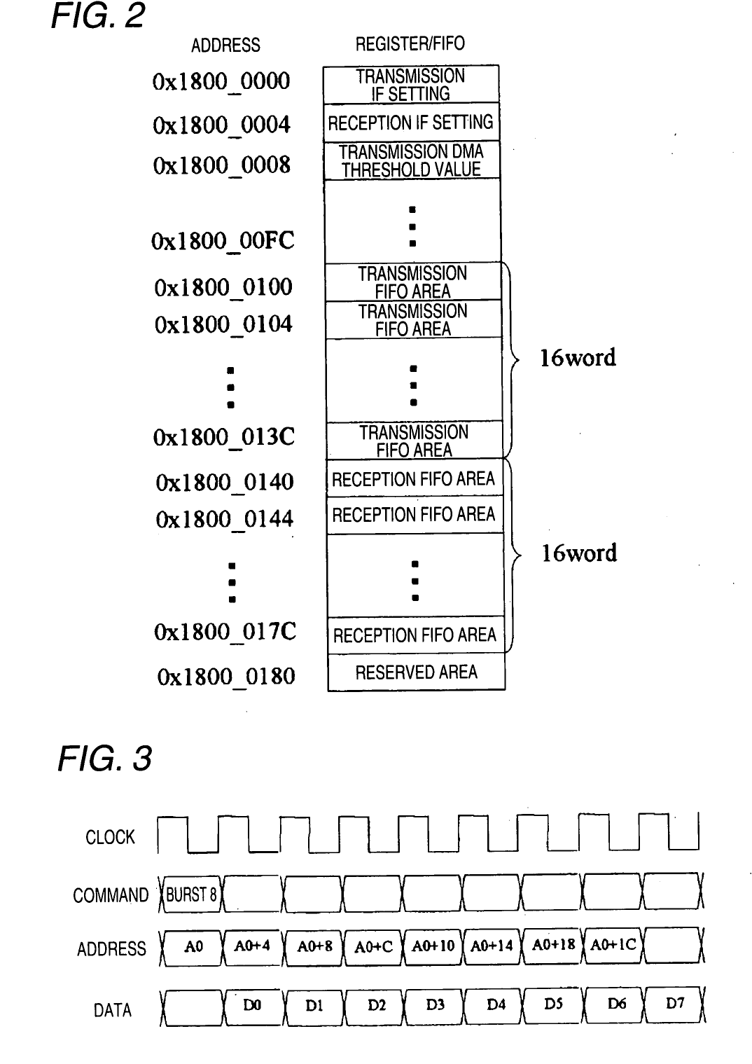

FIG. 2 shows an exemplary address map of the FIFO-incorporated block 103. The address decoder 122 decodes all of accesses to a continuous address area of 16 words into accesses to the transmission FIFO 123, and decodes all of accesses to a continuous address area of the next 16 words into accesses to the reception FIFO 124.

For example, where an address and data each consist of 32 bits, to map a continuous area of 16 words (=64 bytes) to a FIFO, if the higher bits of bit 32 to bit 6 of an address signal coincide with a transmission/reception FIFO area, the address decoder 122 disregards the lower bits of bit 5 to bit 0 and causes access the transmission/reception FIFO 123 or 124 at all times. This procedure, which can be implemented very easily, enables burst access in which data transfers are performed 16 times at the maximum while the address is incremented automatically.

FIG. 3 is a timing chart of a DMA transfer to or from a FIFO in the DMA transfer apparatus according to the invention. First, the DMA control block 102 sends a command to the FIFO-incorporated block 103 according to an addressing mode setting in which a FIFO is designated as a transfer source address or a transfer destination address. Then, burst access is generated to send data consecutively a certain number of times while the address is incremented.

When burst access occurs to a space to which a FIFO is mapped, the FIFO-incorporated block 103 can access the FIFO consecutively in a certain number of cycles to transfer data to the FIFO each time. For example, to transfer data of 8 words, if the DMA control block 101 generates burst access of a burst length 8, the transfer is completed in nine cycles in total, that is, one cycle for sending a command and eight cycles for sending data.

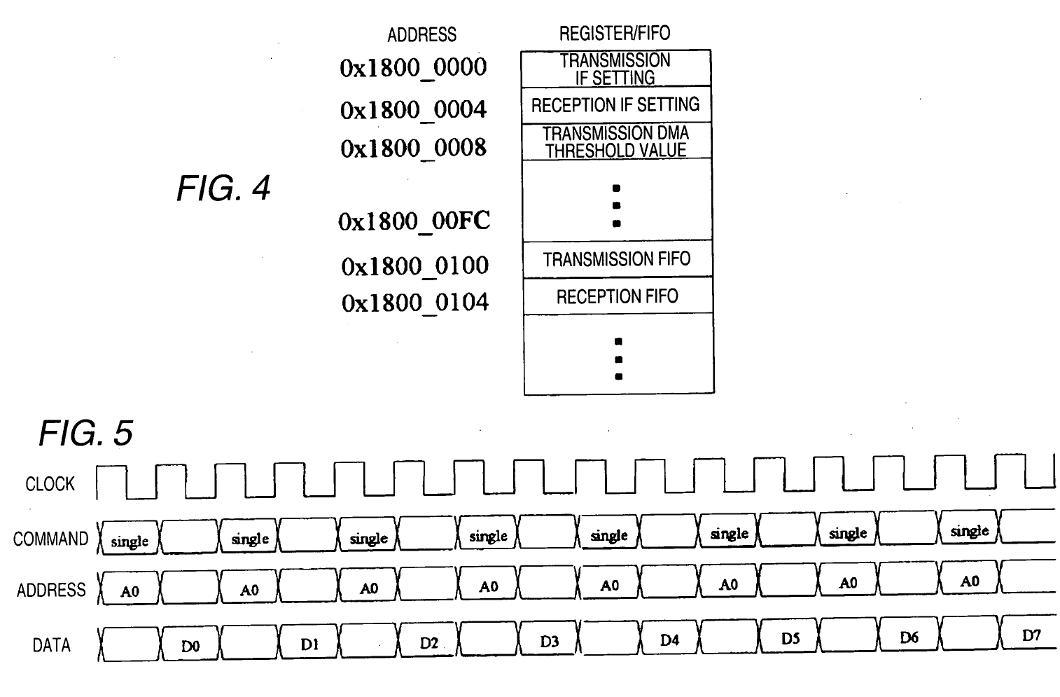

For comparison, FIG. 4 shows an exemplary address map of a conventional FIFO-incorporated device, and FIG. 5 shows a timing chart of a DMA transfer to or from a FIFO. The FIFO is mapped to a single address, and hence a burst transfer cannot be used which is performed while the address is incremented automatically. To transfer data of 8 words, a single transfer in which a command is sent in one cycle and data are transferred only in one cycle is performed repeatedly, which requires 16 cycles in total.

A basic data transfer procedure using the DMA transfer apparatus according to the invention will be described below. The DMA control block 102 has a burst length register 111, a number-of-transfers register 112, a transfer source addressing mode setting register 113, a transfer destination addressing mode setting register 114, a transfer source address register 115, a transfer destination address register 116, and an internal buffer 118 of 16 words.

The CPU 104 can perform data setting on each register via a bus slave interface 110. When receiving a DMA request signal, if the setting value of the number-of-transfers buffer 112 is larger than or equal to the setting value of the burst length register 111, the CPU 104 reads data from an address indicated by the transfer source address register 115 by read access of a burst length that is set in the burst length register 111, temporarily stores the read-out data in the internal buffer 118, and writes the data to an address indicated by the transfer destination address register 116 by write access of the burst length that is set in the burst length register 111.

Every time a transfer is performed, the setting value of the number-of-transfers register 112 is updated through subtraction of the setting value of the burst length register 111 and the values of the transfer source address register 115 and the transfer destination address register 116 are updated according to parameters that are set in the transfer source addressing mode setting register 113 and the transfer destination addressing mode setting register 114, respectively.

Parameters corresponding to “increment,” “decrement, “fixed,” and “dedicated to FIFO transfer” can be set in each of the transfer source addressing mode setting register 113 and the transfer destination addressing mode setting register 114. Values obtained by adding a one-word value to addresses at the end of a transfer, values obtained by subtracting the one-word value to addresses at the end of a transfer, and addresses at the end of a transfer are reflected in the transfer source address register 115 and the transfer destination address register 116 in the increment mode, decrement mode, and fixed mode, respectively.

In the dedicated-to-FIFO-transfer mode, which is an addressing mode unique to the invention, values obtained by subtracting the product of the one-word value and a burst length from addresses at the end of a transfer are reflected in the transfer source address register 115 and the transfer destination address register 116.

In the decrement addressing mode and the fixed addressing mode, a burst transfer which is performed while the address is incremented automatically cannot be used and the value of the burst length register 111 is always fixed at “1.” A value other than “1” can be set in the burst length register 111 only in the increment addressing mode and the dedicated-to-FIFO-transfer addressing mode.

Another configuration is possible in which to perform plural DMA transfers in a time-divisional manner the DMA control block 102 is provided with plural DMA channels each of which has setting registers 111-116 and the bus master interface 117 is provided with a mechanism for performing arbitration when transfers on plural channels occur simultaneously.

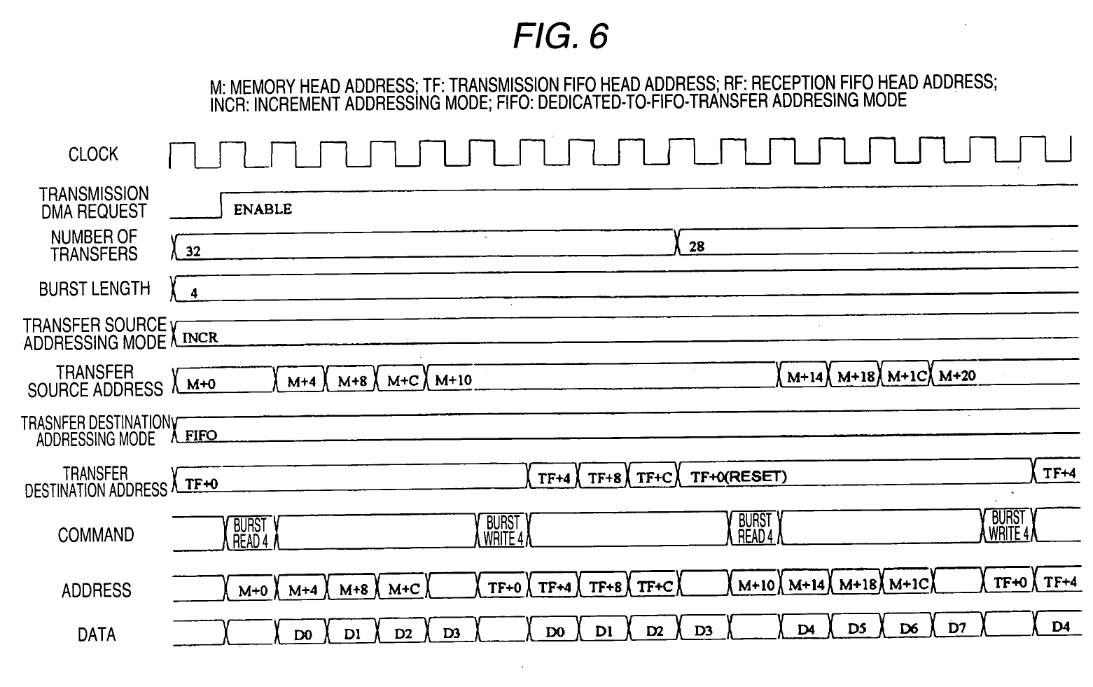

Next, a data transmission procedure of a burst transfer to the transmission FIFO 123 using the DMA transfer apparatus according to the invention will be described in a specific manner with reference to a timing chart of FIG. 6. The transmission interface 125 takes data out of the transmission FIFO 123 and outputs the data to the outside with prescribed timing in a prescribed format. However, its detailed operation is not directly related to the invention and hence will not be described. It is assumed here that the transmission FIFO 123 has a sufficient free area. An operation that is performed when the free area has become small will be described later.

The CPU 104 sets an address of a transfer source area of the memory 105 in the transfer source address register 115 and sets the head address of a transmission FIFO area of the FIFO-incorporated block 103 in the transfer destination address register 116. Furthermore, the CPU 104 sets parameters corresponding to “increment” and “dedicated to FIFO transfer” in the transfer source addressing mode setting register 113 and the transfer destination addressing mode setting register 114, respectively.

The number of transfers corresponding to a necessary data amount is set in the number-of-transfers register 112. A burst length is automatically reflected in the burst length register 111 through an output signal 139 of a transmission burst length selection circuit 135 when the dedicated-to-FIFO-transfer mode is set in the transfer destination addressing mode setting register 114. Therefore, the CPU 104 need not set the burst length register 111.

In the FIFO-incorporated block 103, a comparator 133 compares the values of a number-of-transmission-FIFO-stages register 131 and a threshold value register 129. If the number of FIFO stages is smaller than the threshold value, a DMA request signal 137 is enabled.

In the DMA control block 102, if the DMA request signal 137 is enabled and the setting value of the number-of-transfers register 112 is larger than or equal to the setting value of the burst length register 111, data in the transfer source area of the memory 105 indicated by the value of the transfer source address register 115 are read into the internal buffer 118 by burst reading and then DMA-transferred from the internal buffer 118 to the transmission FIFO 124 indicated by the value of the transfer destination address buffer 116 by burst writing.

After the end of the burst transfer, the number of transfers is decremented by the burst length setting value, the transfer source address is incremented by the number of words of the burst length, and the transfer destination address is decremented by the number of words of the burst length and thereby returned to the address before the start of the burst transfer. By this procedure, the DMA control block 102 transfers data to the transmission FIFO 123 repeatedly by a burst transfer as long as the value of the number-of-transfers register 112 is a positive value.

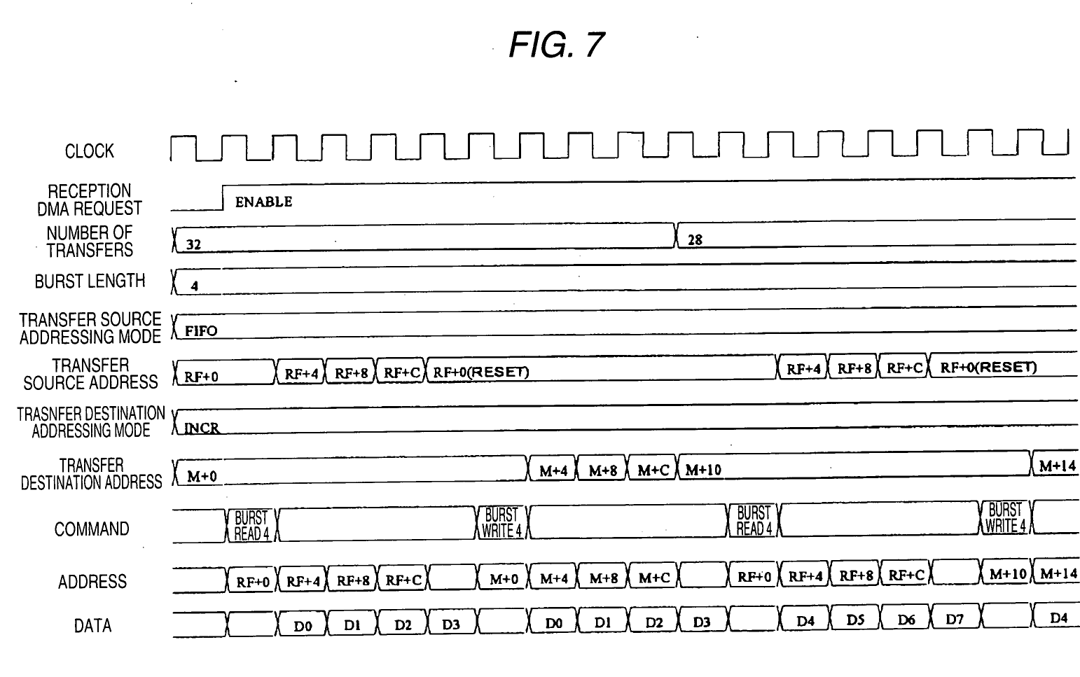

Next, a data reception procedure of a burst transfer from the reception FIFO 124 using the DMA transfer apparatus according to the invention will be described in a specific manner with reference to a timing chart of FIG. 7. A reception interface 126 receives data externally with prescribed timing in a prescribed format and stores the received data in the reception FIFO 124. However, its detailed operation is not directly related to the invention and hence will not be described. It is assumed here that data of a sufficient number of words are stored in the reception FIFO 124. An operation that is performed when the stored data amount has become small will be described later.

The CPU 104 sets the head address of a reception FIFO area of the FIFO-incorporated block 103 in the transfer source address register 115 and sets an address of a transfer destination area of the memory 105 in the transfer destination address register 116. Furthermore, the CPU 104 sets parameters corresponding to “dedicated to FIFO transfer” and “increment” in the transfer source addressing mode setting register 113 and the transfer destination addressing mode setting register 114, respectively.

The number of transfers corresponding to a necessary data amount is set in the number-of-transfers register 112. A burst length is automatically reflected in the burst length register 111 through an output signal 140 of a reception burst length selection circuit 136 when the dedicated-to-FIFO-transfer mode is set in the transfer source addressing mode setting register 113. Therefore, the CPU 104 need not set the burst length register 111.

In the FIFO-incorporated block 103, a comparator 134 compares the values of a number-of-reception-FIFO-stages register 132 and a threshold value register 130. If the number of FIFO stages is larger than the threshold value, a DMA request signal 138 is enabled.

In the DMA control block 102, if the DMA request signal 138 is enabled and the setting value of the number-of-transfers register 112 is larger than or equal to the setting value of the burst length register 111, data in the reception FIFO 124 indicated by the value of the transfer source address buffer 115 are read into the internal buffer 118 by burst reading and then DMA-transferred from the internal buffer 118 to the transfer destination area of the memory 105 indicated by the value of the transfer destination address register 116 by burst writing.

After the end of the burst transfer, the number of transfers is decremented by the burst length setting value, the transfer destination address is incremented by the number of words of the burst length, and the transfer source address is decremented by the number of words of the burst length and thereby returned to the address before the start of the burst transfer. By this procedure, the DMA control block 102 transfers data from the reception FIFO 124 repeatedly by a burst transfer as long as the value of the number-of-transfers register 112 is a positive value.

The address decoder 122 receives a signal indicating a burst length from the bus interface section 121. If an address at the start of a burst transfer is in a space to which a FIFO is mapped and an address at the end of the burst transfer (i.e., a burst-length-added address) will be out of the space to which the FIFO is mapped, the address decoder 122 detects occurrence of an address overrun and sends an error notification signal 142 back to the DMA control block 102.

When receiving the error notification signal 142, the DMA control block 102 stops the DMA transfer. In this embodiment, an address space that is mapped to the transmission FIFO 123 or the reception FIFO 124 corresponds to 16 words and the burst length is 16 words at the maximum. Therefore, no address overrun occurs with any burst length if a burst transfer is started from the head address of a FIFO area.

In each burst transfer, the value of the transfer source address register 115 or the transfer destination address register 116 that indicates a FIFO is returned to an address before the burst transfer. Therefore, by always setting the head address of a FIFO as a transfer source or destination address, software to follow the transfer procedure using the DMA transfer apparatus according to the invention can use the DMA transfer apparatus according to the invention without being aware of the fact that addresses to which the FIFO is mapped constitute a continuous area merely by changing the addressing mode of conventional DMA control software from “fixed” to “dedicated to FIFO transfer.”

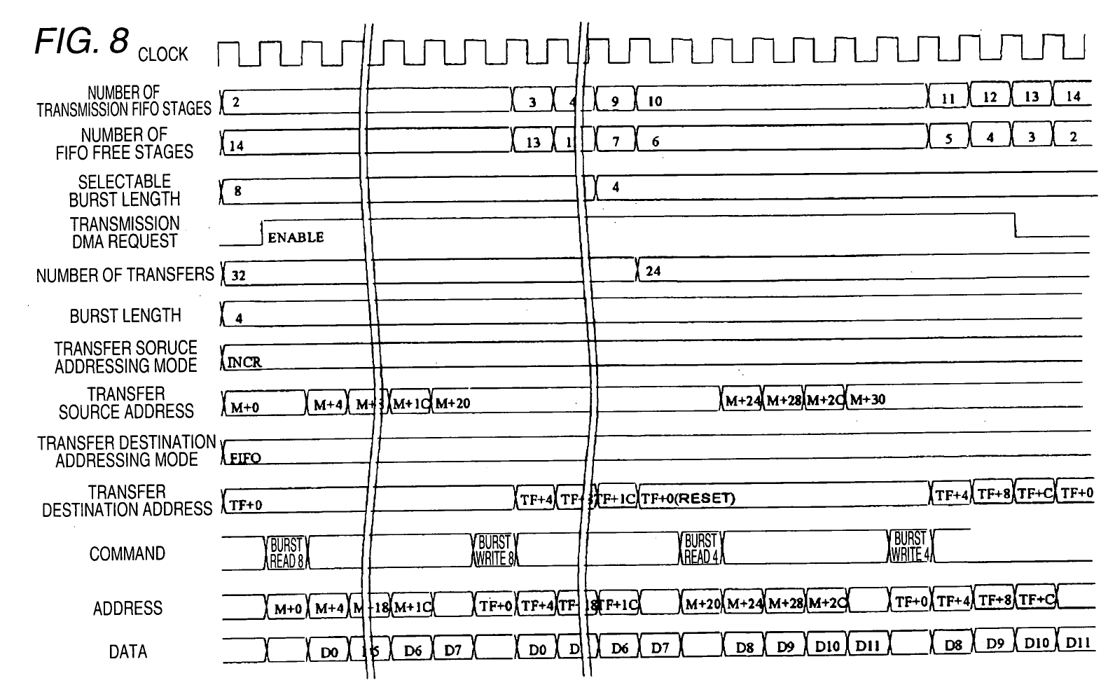

FIG. 8 is a timing chart showing a burst length control for avoiding an overflow of the transmission FIFO 123 in the DMA transfer apparatus according to the invention. The value of the number-of-transmission-FIFO-stages register 131 which is provided in the FIFO-incorporated block 103 is incremented by one every time data are stored in the transmission FIFO 123 and is decremented by one every time data are loaded into the transmission interface 125. As such, the number-of-transmission-FIFO-stages register 131 always stores the number of words of the data stored in the 16-stage transmission FIFO 123.

The transmission burst length selection circuit 135 is controlled, on the basis of the value of the number-of-transmission-FIFO-stages register 131 and a burst length table 141, so as to select a maximum burst length that does not cause an overflow. In the example of FIG. 8, in the first transfer, since the value of the number-of-transmission-FIFO-stages register 131 is “2,” a free area of 14 words is available and hence the transmission burst length selection circuit 135 selects a maximum burst length “8” that is smaller than the value “14.” In the second transfer, since the value of the number-of-transmission-FIFO-stages register 131 is “10,” a free area of 6 words is available and hence the transmission burst length selection circuit 135 selects a maximum burst length “4” that is smaller than the value “10.”

Where the dedicated-to-FIFO-transfer mode is set in the transfer destination addressing mode register 114, the value of the burst length register 111 of the DMA control block 102 is updated to a burst length that is selected in each burst transfer. As a result, a DMA transfer can always be performed with a longest burst length without occurrence of a FIFO overflow, whereby the bus occupation time can be minimized. Since a value “12” is set in the transmission FIFO threshold value register 129, a DMA request is made invalid at the end of the second transfer.

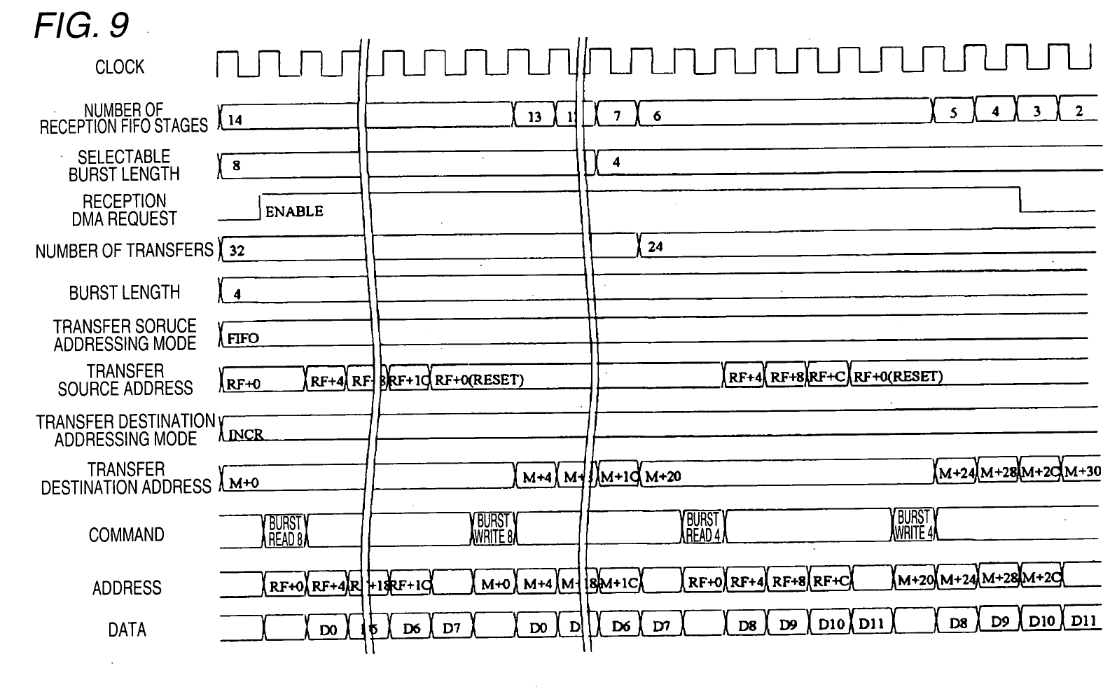

FIG. 9 is a timing chart showing a burst length control for avoiding an underflow of the reception FIFO 124 in the DMA transfer apparatus according to the invention. The value of the number-of-reception-FIFO-stages register 132 which is provided in the FIFO-incorporated block 103 is incremented by one every time data are stored from the reception interface 126 and is decremented by one every time data are loaded from the reception FIFO 124. As such, the number-of-reception-FIFO-stages register 132 always stores the number of words of the data stored in the 16-stage reception FIFO 124.

The reception burst length selection circuit 136 is controlled, on the basis of the value of the number-of-reception-FIFO-stages register 132 and the burst length table 141, so as to select a maximum burst length that does not cause an underflow. In the example of FIG. 9, in the first transfer, since the value of the number-of-reception-FIFO-stages register 132 is “14,” the reception burst length selection circuit 136 selects a maximum burst length “8” that is smaller than the value “14.” In the second transfer, since the value of the number-of-reception-FIFO-stages register 132 is “6,” the reception burst length selection circuit 136 selects a maximum burst length “4” that is smaller than the value “6.”

Where the dedicated-to-FIFO-transfer mode is set in the transfer source addressing mode register 113, the value of the burst length register 111 of the DMA control block 102 is updated to a burst length that is selected in each transfer. As a result, a transfer can always be performed with a longest burst length without occurrence of a FIFO underflow, whereby the bus occupation time can be minimized. Since a value “4” is set in the reception FIFO threshold value register 130, a DMA request is made invalid at the end of the second transfer.

To minimize the degree of alteration of the FIFO-incorporated block 103, a configuration is possible in which the values of the number-of-transmission-FIFO-stages register 131 and the number-of-reception-FIFO-stages register 132 are communicated and the transmission burst length selection circuit 135, the reception burst length selection circuit 136, and the burst length table 141 are disposed inside the DMA control block 102.

The invention is not limited to the above-described configuration of the embodiment, and various modifications to the FIFO depth, the settable burst length, the address map, the circuit configuration of the address decoder, the functions of the respective setting registers, etc. are possible without departing from the spirit and scope of the invention.

In a signal processing system in which an interface for a high-speed memory or the like and a low-speed FIFO-incorporated device exist in mixture, the DMA transfer apparatus according to the invention can increase the system performance particularly in such a manner that the clock frequency is not increased and the power consumption is kept low. As such, it is expected that the DMA transfer apparatus according to the invention is advantageous when implemented in, for example, a system LSI for mobile use.

What is claimed is:

1. A DMA transfer apparatus comprising:
a DMA control block connected, as a bus master, to a DMA bus capable of burst transfer and having a function of controlling a burst transfer by generating burst access for sending data consecutively a certain number of times while incrementing the address after sending a command; and
a FIFO-incorporated block connected the DMA bus as a slave thereof and having a FIFO whose address is mapped to a continuous address space.

2. The DMA transfer apparatus according to claim 1, wherein the FIFO-incorporated block comprising an address decoder for detecting, at a start of burst access, that an address at an end of a burst transfer will exceed the address space of the FIFO, and outputting an error notice.

3. The DMA transfer apparatus according to claim 1, wherein the DMA control block comprises:
a control register section in which a CPU sets transfer parameters;
a bus interface section capable of generating burst access via the DMA bus according to the parameters set in the control register section; and
an addressing mode in which addition to a transfer destination address or a transfer source address is performed during a burst transfer and subtraction into an address at a start of the burst transfer is performed automatically at an end of the burst transfer.

4. The DMA transfer apparatus according to claim 1, wherein the FIFO-incorporated block comprises:
a transmission FIFO for receiving and outputting data of plural stages;
an output interface section for taking data out of the transmission FIFO and outputting the data to the outside in a prescribed format; and
a burst length selection circuit for informing the DMA control block of a maximum burst length that does not cause a FIFO overflow on the basis of the number of stages of data stacked in the transmission FIFO and a usable burst length setting value table.

5. The DMA transfer apparatus according to claim 1, wherein the FIFO-incorporated block comprises:
a reception FIFO for receiving and outputting data of plural stages;
an input interface section for receiving data externally in a prescribed format and loading the data into the reception FIFO; and
a burst length selection circuit for informing the DMA control block of a maximum burst length that does not cause a FIFO underflow on the basis of the number of stages of data stacked in the reception FIFO and a usable burst length setting value table.

6. The DMA transfer apparatus according to claim 1, wherein the DMA control block comprises a burst length selection circuit capable of generating burst access of a burst length that is a plural number, for selecting, in each data transfer, access of a maximum burst length that does not cause a FIFO overflow or underflow on the basis of the number of stages of data stored in the FIFO and a usable burst length setting value table.

7. A semiconductor integrated circuit incorporating the DMA transfer apparatus according to claim 1.
